(19) United States
(12) Patent Application Publication
(10) Pub. No.: US 2008/0036247 A1
(43) Pub. Date: Feb. 14, 2008

(54) Sunroof decoration cover assembly

(76) Inventor: Jeong Hoon Park, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/604,592

(22) Filed: Nov. 27, 2006

(30) Foreign Application Priority Data
Aug. 10, 2006 (KR) 10-2006-0075645

(51) Int. Cl. B60J 7/22

(52) U.S. Cl. 296/217

(57) ABSTRACT

A sunroof decoration cover assembly includes: a guide rail frame provided with a guide rail and coupled to a vehicle body; an operational mechanism, which is operated along the guide rail to open and close a sunroof window unit; a front assembly portion formed on the operational mechanism; a rear assembly portion provided with a drip rail coupled to the guide rail frame; a sunroof decoration cover supported by a sunroof decoration cover guide and covering the operational mechanism; a front assembly unit provided on the sunroof decoration cover guide and coupled to the front assembly portion; a rear assembly unit provided on the sunroof decoration cover guide and coupled to the rear assembly portion; and an upper coupling unit provided on the upper portion of the sunroof decoration cover and coupled to the sunroof window unit.

### CROSS-REFERENCE TO RELATED APPLICATION

This application claims priority to Korean Patent Application No. 10-2006-0075645 filed in the Korean Intellectual Property Office on Aug. 10, 2006, the disclosure of which is incorporated herein by reference.

### BACKGROUND OF THE INVENTION

(a) Field of the Invention

The present invention relates to a sunroof decoration cover assembly. In particular, the present invention relates to a sunroof decoration cover assembly that can completely enclose the operation unit for opening/closing a sunroof.

(b) Description of the Related Art

A sunroof is a roof window installed in the roof of a vehicle to provide a more comfortable driving environment by being opened when the interior temperature rises.

Sunroofs are generally classified into manual types and motor driven types. A pop-up type is a well known as the manual type sunroof. The pop-up type is designed to be opened from the rear end by the manipulation of a handle installed inside the vehicle. The motor driven type sunroof is further classified into two types, an inner sliding sunroof and an outer sliding sunroof. The inner sliding sunroof is opened when a glass window slides into the roof of the vehicle. The outer sliding sunroof is opened when a glass window slides backwards above the roof of the vehicle. The motor driven type sunroof has a mechanism for opening and closing the glass window regardless if it is an inner sliding sunroof or an outer sliding sunroof.

However, a drawback of the sunroof is that the operational mechanism is exposed to an external side, thereby deteriorating over time. Furthermore, another drawback of a conventional sunroof decoration cover is that it cannot fully enclose the mechanism, making it difficult to install on a vehicle.

In order to solve these drawbacks, the present invention provides a sunroof decoration cover for covering the exposed mechanism.

### SUMMARY OF THE INVENTION

The present invention provides a sunroof decoration cover assembly that is designed to fully cover a mechanism. The present invention also provides a sunroof decoration cover assembly that is designed as a simple structure that can be easily mounted and dismounted.

An exemplary embodiment of the present invention provides a sunroof decoration cover assembly including: a guide rail frame provided with a guide rail and coupled to a vehicle body; an operational mechanism, which is operated along the guide rail to open and close a sunroof window unit; a front assembly portion formed on the operational mechanism; a rear assembly portion provided on a drip rail coupled to the guide rail frame; a sunroof decoration cover supported by a sunroof decoration cover guide and covering the operational mechanism; a front assembly unit provided on the sunroof decoration cover guide and coupled to the front assembly portion; a rear assembly unit provided on the sunroof decoration cover guide and coupled to the rear assembly portion; and an upper coupling unit provided on the upper portion of the sunroof decoration cover and coupled to the sunroof window unit.

In one embodiment, the sunroof decoration cover may include a plurality of plates that are connected with each other so that they can be folded and unfolded as the sunroof window unit opens and closes.

In another embodiment, the sunroof window unit includes a sunroof glass for blocking direct sunlight, a sunroof glass bracket that is connected to the operational mechanism to support the sunroof glass so that the sunroof window unit can be opened and closed by the operational mechanism, and a sunroof glass support panel that is coupled to the sunroof glass bracket to support the sunroof glass.

In another embodiment, the upper coupling unit may be coupled to the sunroof glass support panel and the upper coupling unit may comprise a clip.

In another embodiment, the front assembly portion may be provided with a slot in which the front assembly unit is coupled. In another embodiment, the rear assembly portion may be provided with a slot in which the rear assembly unit is coupled.

In another embodiment, the slot of the rear assembly portion may be longer than the slot of the front assembly portion.

In another embodiment, a hook portion may be formed on an end of the front assembly unit to prevent the front assembly unit from being separated from the front assembly portion.

In another embodiment, a reinforcing portion is formed on a side surface of the front assembly unit.

In another embodiment, a hook portion may be formed on an end of the rear assembly unit to prevent the rear assembly unit from being separated from the rear assembly portion.

In another embodiment, a reinforcing portion may be formed on a side surface of the rear assembly unit.

In another embodiment, the reinforcing portion of the rear assembly unit includes a first reinforcing portion and a second reinforcing portion.

### BRIEF DESCRIPTION OF THE DRAWINGS

FIG. 1 is a schematic view illustrating the mounting of a sunroof decoration cover according to an exemplary embodiment of the present invention.

FIG. 2 is a schematic view of the coupling of a front portion of a sunroof cover according to an exemplary embodiment of the present invention.

FIG. 3 is a schematic view of a coupling of a rear portion of a sunroof cover according to an exemplary embodiment of the present invention.

FIG. 4 is a perspective view from the bottom illustrating the mounted state of the sunroof decoration cover according to an exemplary embodiment of the present invention.

FIG. 5 is a cross-sectional view taken along line V-V as shown in FIG. 4.

### DETAILED DESCRIPTION OF THE INVENTION

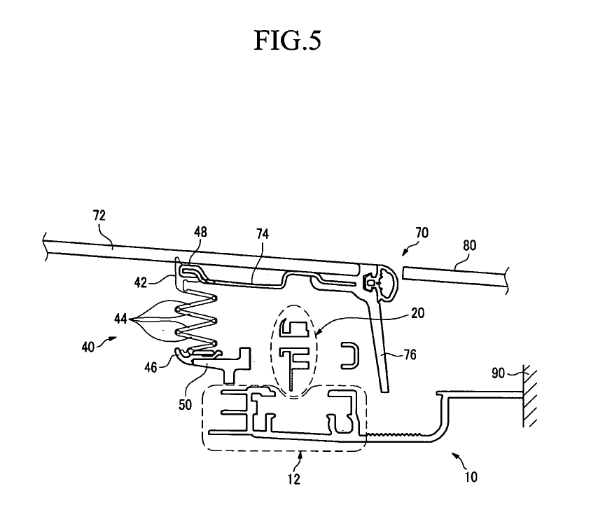

As shown in FIG. 5, a guide rail frame 10 is provided on a vehicle body 90. The guide rail frame 10 is provided with a guide rail 12. The guide rail 12 is provided with an operational mechanism 20. The operational mechanism 20 operates along the guide rail 12 to open and close a sunroof window unit 70. The sunroof glass window unit 70 includes: a sunroof glass 72 for blocking direct sunlight; a sunroof glass bracket 76 that is connected to the operational mechanism 20 to support the sunroof glass 72; and a sunroof glass support panel 74 that is coupled to a sunroof glass bracket 76 which supports the sunroof glass 72. The sunroof glass window unit 70 is opened and closed by the operational mechanism 20.

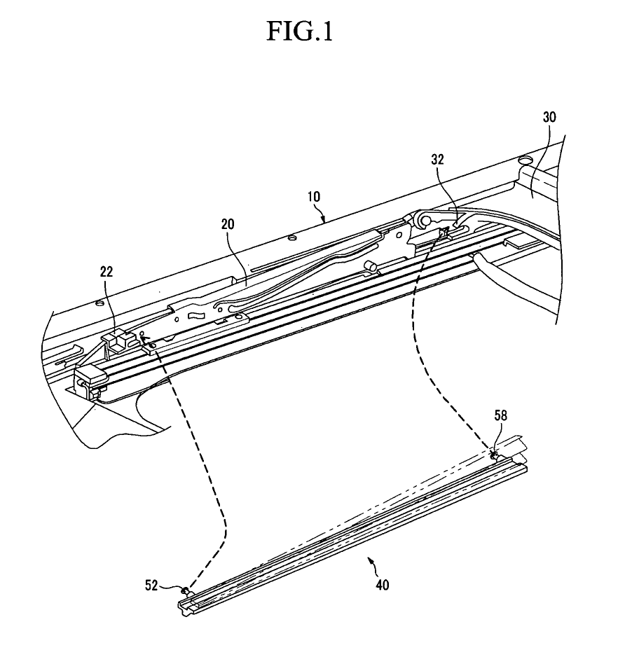

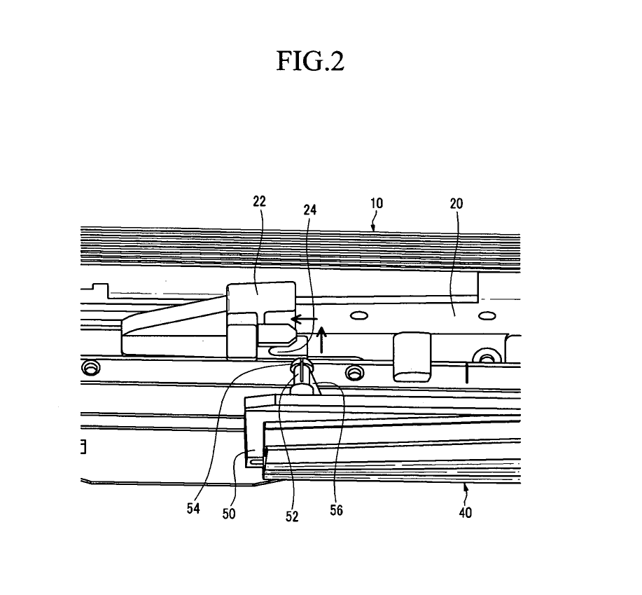

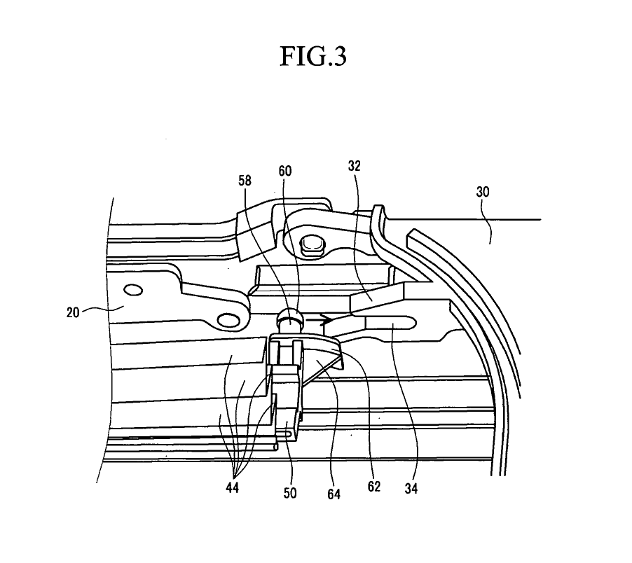

The operational mechanism 20 is provided with a front assembly portion 22 (see FIGS. 1 and 2). A drip rail 30 (see FIGS. 1 and 3) is coupled to the guide rail frame 10. When the sunroof is opened, the drip rail 30 is also opened. The drip rail prevents water from flowing into the interior of the vehicle. The drip rail 30 is provided with a rear assembly portion 32 (see FIGS. 1 and 3).

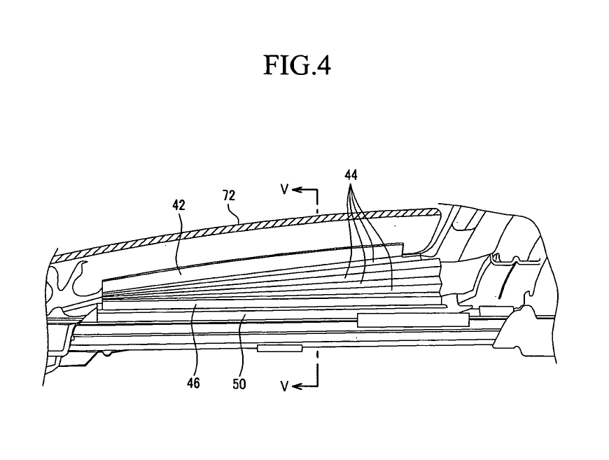

The sunroof decoration cover 40 covers the operational mechanism 20. A lower portion 46 of the sunroof decoration cover 40 is coupled to and supported by a cover guide 50 (see FIGS. 4 and 5).

Hereinafter, the coupling of the front assembly portion with a front assembly unit will be described.

Referring to FIG. 2, the sunroof decoration cover guide 50 is provided with a front assembly unit 52 that is coupled to the front assembly portion 22. The front assembly portion 22 is provided with a slot 24 in which the front assembly unit 52 is coupled. A hook portion 54 is formed on an end of the front assembly unit 52 to prevent the front assembly unit 52 from being separated from the front assembly portion 22. A reinforcing portion 56 is formed on the side surface of the front assembly unit 52 to prevent the front assembly unit 52 from being broken.

The following will describe a coupling of the rear assembly portion to a rear assembly unit.

Referring to FIG. 3, the sunroof decoration cover guide 50 is provided with a rear assembly unit 58 coupled to the rear assembly portion 32. The rear assembly portion is provided with a slot 34 in which the rear assembly unit 58 is coupled. A hook portion 60 is formed on an extreme end of the assembly unit 58 to prevent the rear assembly unit 58 from being separated from the rear assembly portion 32. A first reinforcing portion 62 is formed on a side surface of the rear assembly unit 58 to be perpendicular to the rear assembly unit 58. There is also a second reinforcing portion 64 which is formed on the side surface of the rear assembly unit 58 to be perpendicular to the rear assembly unit 58. Since the upward/downward movement of the rear assembly unit 58 is greater than that of the front assembly unit 52, it is preferable that it have two reinforcing portions, i.e., the first reinforcing portion 62 perpendicular to the rear assembly unit 58 and the second reinforcing portion 64 perpendicular to the rear assembly unit 58 and the first reinforcing portion 62.

The following will describe an installed state of the sunroof decoration cover 40.

As shown in FIG. 4, the sunroof decoration cover 40 fully encloses the operational mechanism 20.

Referring to FIG. 5, the sunroof decoration cover 40 includes a plurality of plates 44 that are connected with each other such that they can be folded and unfolded as the sunroof glass window unit 70 opens and closes. As the sunroof glass window unit 70 opens or closes, the sunroof decoration cover 40 opens and closes together with the sunroof glass window unit 70 so that the operational mechanism 20 will always be covered by the sunroof decoration cover 40.

The following will describe an assembling process of the sunroof decoration cover 40.

As shown in FIG. 3, the rear assembly unit 58 is coupled to the rear assembling portion 32 while moving in the direction of the arrow.

Then, as shown in FIG. 2, the front assembly unit 52 is coupled to the front assembling portion 22 while moving in the direction of the arrow.

Here, the slot 34 of the rear assembly portion 32 is longer than the slot 24 of the front assembly portion 22 in order to prevent the rear assembly unit 58 from being separated from the rear assembly portion 32 after the front assembly unit 52 is coupled to the front assembly portion 22. The drawings show a case where the slot 34 of the rear assembly portion 32 is longer than the slot 24 of the front assembly portion 22. However, the present invention is not limited to this example. In another embodiment, the slot 24 may be longer than the slot 34.

The following will describe an assembling process of an upper assembly unit.

As shown in FIG. 5, the sunroof glass window unit 70 includes: the sunroof glass 72 which blocks direct sunlight; the sunroof glass bracket 76 that is connected to the operational mechanism 20 to support the sunroof glass 72; and the sunroof glass support panel 74 that is coupled to the sunroof glass bracket 76 to support the sunroof glass 72. The sunroof glass window unit 70 is opened and closed by the operational mechanism 20.

The sunroof decoration cover 40 is provided at the upper portion 42 by an upper assembly unit 48. The upper assembly unit 48 is coupled to the sunroof glass support panel 74. The upper assembly unit 48 is formed as a clip so that it can be easily mounted and dismounted.

As described above, when the slot 34 is longer than the slot 24, the sunroof decoration cover 40 is assembled according to the following process. First, the rear assembly unit 58 is coupled to the rear assembly portion 32 and then the front assembly unit 52 is coupled to the front assembly portion 22. Lastly, the upper assembly unit 48 is coupled.

When the slot 34 is shorter than the slot 24, the sunroof decoration cover 40 is assembled according to the following process. The front assembly unit 52 is first coupled to the front assembling portion 22 and then the rear assembly unit 58 is coupled to the rear assembly portion 32. Lastly, the upper assembly unit 48 is coupled.

The disassembling process of the sunroof decoration cover 40 is performed in the opposite order.

That is, when the slot 34 is longer than the slot 24, the upper assembly unit 48 is first disassembled and then the front assembly unit 52 is disassembled. Lastly, the rear assembly unit 58 is disassembled. When the slot 34 is shorter than the slot 24, the upper assembly unit 48 is first disassembled and then the rear assembly unit 58 is disassembled. Lastly, the front assembly unit 52 is disassembled.

Since the sunroof decoration cover assembly is simple in structure it can be easily assembled and disassembled. The sunroof decoration cover can be manufactured as an independent member thereby reducing the maintenance costs. Furthermore, this sunroof decoration cover assembly fully encloses the operational mechanism. Therefore, the decoration effect is enhanced by the sunroof decoration cover and thus the marketability of a vehicle with a sunroof is greatly improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A sunroof decoration cover assembly comprising:
a guide rail frame provided with a guide rail and coupled to a vehicle body;
an operational mechanism, which is operated along the guide rail to open and close a sunroof window unit;
a front assembly portion formed on the operational mechanism;
a rear assembly portion provided on a drip rail coupled to the guide rail frame;
a sunroof decoration cover supported by a sunroof decoration cover guide and covering the operational mechanism;
a front assembly unit provided on the sunroof decoration cover guide and coupled to the front assembly portion;
a rear assembly unit provided on the sunroof decoration cover guide and coupled to the rear assembly portion; and
an upper coupling unit provided on an upper portion of the sunroof decoration cover and coupled to the sunroof window unit.

2. The sunroof decoration cover assembly of claim 1, wherein the sunroof decoration cover includes a plurality of plates that are connected with each other wherein the plurality of plates can be folded and unfolded as the sunroof window unit opens and closes.

3. The sunroof decoration cover assembly of claim 1, wherein the sunroof window unit comprises:
a sunroof glass for blocking direct sunlight;
a sunroof glass bracket that is connected to the operational mechanism to support the sunroof glass wherein the sunroof window unit can be opened and closed by the operational mechanism; and
a sunroof glass support panel that is coupled to the sunroof glass bracket to support the sunroof glass.

4. The sunroof decoration cover assembly of claim 3, wherein the upper coupling unit is coupled to the sunroof glass support panel and the upper coupling unit includes a clip.

5. The sunroof decoration cover assembly of claim 1, wherein the front assembly portion is provided with a slot in which the front assembly unit is coupled.

6. The sunroof decoration cover assembly of claim 5, wherein the rear assembly portion is provided with a slot in which the rear assembly unit is coupled.

7. The sunroof decoration cover assembly of claim 6, wherein the slot of the rear assembly portion is longer than the slot of the front assembly portion.

8. The sunroof decoration cover assembly of claim 1, wherein a hook portion is formed on an end of the front assembly unit to prevent the front assembly unit from being separated from the front assembly portion.

9. The sunroof decoration cover assembly of claim 8, wherein a reinforcing portion is formed on a side surface of the front assembly unit.

10. The sunroof decoration cover assembly of claim 1, wherein a hook portion is formed on an end of the rear assembly unit to prevent the rear assembly unit from being separated from the rear assembly portion.

11. The sunroof decoration cover assembly of claim 10, wherein a reinforcing portion is formed on a side surface of the rear assembly unit.

12. The sunroof decoration cover assembly of claim 11, wherein the reinforcing portion includes a first reinforcing portion perpendicular to the rear assembly unit and a second reinforcing portion perpendicular to the rear assembly unit and the first reinforcing portion.
